(19) United States
(12) Patent Application Publication
(10) Pub. No.: US 2011/0210277 A1
(43) Pub. Date: Sep. 1, 2011

(54) ELECTROMAGNETIC REGULATOR

(75) Inventor: Stefan Bender, Engen (DE)

(73) Assignee: ETO MAGNETIC GMBH, Stockach (DE)

(21) Appl. No.: 13/120,898

(22) PCT Filed: Oct. 6, 2009
(86) PCT No.: PCT/EP09/07158

§ 371 Date: Mar. 24, 2011

(30) Foreign Application Priority Data
Oct. 17, 2008 (DE) 202008013654.7

(51) Int. Cl. F16K 31/02

(52) U.S. Cl. 251/129.01

(57) ABSTRACT

An electromagnetic regulator having an armature unit with a plunger unit (12) carrying out a linear movement when energized by a current flowing in a stationary coil unit (26, 38), wherein the plunger unit is designed to cooperate at the end thereof with a regulator partner (10). The plunger unit has a slide or ball bearing (36) at the end thereof which is fixed in a cage-like housing (38, 40) on the plunger unit such as to be able to rotate in reaction to a frictional force at right angles to the direction of the linear regulation movement.

### BACKGROUND OF THE INVENTION

The present invention relates to an electromagnetic actuating device. A device of this kind is well known from the prior art and is often used to actuate a (switching) valve and, in devices of the type in question, the electromagnetically driven armature unit interacts as an actuating partner with a valve slide or similar constructional unit of a switching valve of this kind in order to exert an actuating force by means of the linear actuating movement.

One specific application which may be assumed to be known for devices of the type in question is adjustment of the camshaft of an internal combustion engine. Here, the actuating device of the type in question, as a pressure valve, is situated in an axial position relative to the engine camshaft. The vertically mounted actuating device makes contact by means of a front end surface of the plunger unit with the valve that effects camshaft adjustment.

Manufacturing tolerances, thermally induced effects or the like dimension-influencing factors can lead to an axial offset between the switching valve (more precisely a valve slide or similar unit thereof), on the one hand, and the plunger of the actuating device, on the other hand, i.e. respective longitudinal axes through these elements are no longer in alignment but are at a distance from one another.

In devices existing in practice, this leads, for instance, to the end face of a valve slide unit which is interacting in an axially offset manner with the plunger unit exerting a radial force on the plunger unit during the movement of said valve slide unit, with the result that there is friction at the transitional surface or surface where the force is introduced, this friction causing unwanted abrasion of the material or even inability of the plunger unit to operate. For this reason, one known practice from the prior art is either to design the plunger unit with a tapering geometry and additionally or, as an alternative, to use hardening measures to make the engagement end of the plunger unit less sensitive to unwanted abrasion of material than a valve slide or similar actuating partner. Nevertheless, it has been found in practice that it is precisely the difficult-to-avoid axial offset described above between the actuating partner and the plunger unit which leads to a considerable reduction in service life.

It is therefore the object of the present invention to improve an electromagnetic actuating device of the type in question especially in respect of damaging frictional or transverse forces acting on a front end surface or engagement surface at the end of the plunger unit owing to interaction between the plunger unit and the actuating partner in a manner which is not aligned or coaxial but is axially offset.

### SUMMARY OF THE INVENTION

The object is achieved by an electromagnetic actuating device having a plunger unit provided with a cage-like holding portion, into which a running or bearing ball is inserted rotatably in such a way that it can perform a rotary movement in the holding portion in reaction to the frictional or transverse force described above on the ball and in this way significantly reduces any possible friction-related abrasion of the material.

Here, the holding portion is preferably formed in such a way at the end of the plunger unit that, being formed integrally, that is to say from the material of the plunger unit and without an additional component, it acts in such a way that, on the one hand, an interior space (as a receiving chamber for the ball) is delimited or closed off in an effective manner, thus preventing the ball from falling out, while at the same time, however, allowing it to emerge by a predetermined amount from the cage-like holding portion in order to perform its running and bearing action and, on the other hand, that the prerequisites for reliable and free rolling (rolling movement) in a way which absorbs frictional forces in the manner described are provided within the receiving chamber.

For this purpose, it is advantageous to configure an edge portion at the end of the receiving chamber to form a locking portion by appropriate inward flanging or folding (i.e. flanging or folding radially toward the center line), the corresponding wall portion in this embodiment of the invention being produced, with the running or bearing ball inserted, through the appropriate use of a tool for deformation. It is advantageous to set the (radial) extent of flanging, i.e. the reduction in the clear width in the transverse direction (and hence perpendicularly to the linear actuating movement of the plunger unit) to about 0.5% to 5%, relative to the diameter of the ball.

As an alternative and as a further preferred embodiment of the invention, provision is made (once again in an integral embodiment at the engagement end of the plunger unit) to form the end wall of the receiving chamber with an undercut which, once again, delimits a clear width of the receiving chamber (by running radially all the way round or around a section or sections) and in this way prevents the ball from falling out accidentally, thus producing the snap-fitting and/or locking effect according to the invention.

In this way, not only is it possible, reliably and advantageously in the manner described, to construct a receptacle for a running or bearing ball for force transmission to the actuating partner in a manner which reduces friction and stress on the material, but a procedure of this kind is simple in terms of assembly, not least because the running or bearing ball can be inserted into the holding cage simply by snapping or clipping it in.

It is within the scope of preferred developments of the invention to configure the inside width of the holding portion, i.e. a radial width of the receiving chamber for the running or bearing ball, with an oversize or clearance relative to the ball diameter in such a way that, on the one hand, reliable rotation, without jamming, is made possible in the desired manner and that, on the other hand, unwanted transverse movements of the ball are prevented. According to a development, appropriate configuration of the depth of the receiving chamber also ensures that the ball projects axially from the holding portion by 10% to 30%, once again relative to a ball outside diameter, for reliable actuating force transmission to the actuating partner.

While, as described at the outset with reference to the prior art assumed as defining the type in question, the present invention is suitable especially for avoiding an axial offset between the plunger unit and an actuating partner due to manufacturing tolerances or to temperature and a frictional effect caused thereby, the present invention is not limited to this application and is suitable in principle for any application involving the transmission of force exerted by a plunger unit on the engagement side of an actuating partner. The “valve positioning” application is also preferred, as is the adjustment of a camshaft or similar unit on an internal combustion engine, but the area of application and the use of the present invention is not limited thereto.

### BRIEF DESCRIPTION OF THE DRAWINGS

Further advantages, features and details of the invention will emerge from the following description of preferred illustrative embodiments and with reference to the drawings, in which:

FIG. 1: shows a longitudinal section through an electromagnetic actuating device as an actuating magnet for camshaft adjustment in accordance with a first preferred embodiment of the invention;

FIG. 2: shows an enlarged detail view similar to FIG. 1 with an actuating partner offset axially by a predetermined amount of offset, and

FIG. 3: shows a detail view of the cage-like holding portion provided at the end of the plunger unit, with a running or bearing ball inserted by means of a snap fit.

### DETAILED DESCRIPTION

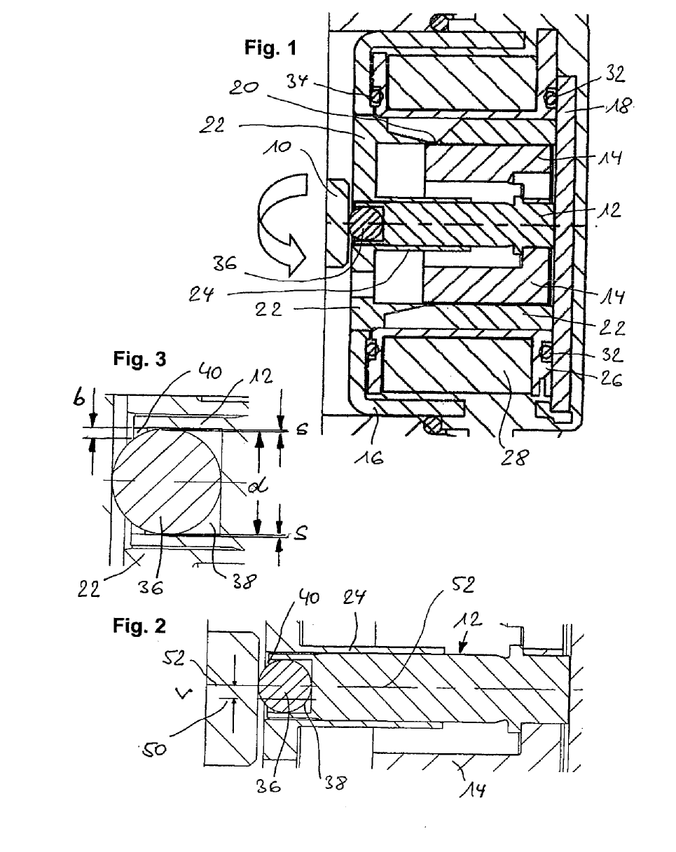

FIG. 1 shows, in a sectioned side view, the basic structure and the peripheral elements of the electromagnetic actuating device according to a first preferred embodiment, mounted for camshaft adjustment by means of a pressure force on a valve slide 10 (shown purely schematically and in section) of a switching valve unit (not shown) for camshaft adjustment on an internal combustion engine.

The linear thrust (to the left in the axial direction in the plane of the drawing in FIG. 1) on the valve slide unit 10 is exerted by a plunger unit 12, which is part of an armature unit of the electromagnetic actuating device shown and, together with a cup-shaped armature portion 14, forms the armature unit, which is guided in such a way that it can be moved within a two-part housing comprising a housing shell 16 and a housing base 18. More precisely, said armature unit 12, 14 is surrounded, for the purpose of forming a magnetic circuit, by a yoke core unit 22, which, in the present illustrative embodiment, is formed integrally with an interposed central portion 20 tapered conically on both sides, forms an outlet opening at the end for the plunger unit 12 and, in this area, offers a hollow-cylindrical plunger guide 24 which surrounds the plunger unit at the lateral surface over a predetermined section of the axial length thereof.

The yoke core unit 22, in turn, is surrounded radially by a coil unit, which is formed by a coil holder 26 carrying a winding 28 in a manner which is in other respects known. Energization of said winding then leads to the electromagnetic field of the winding driving the armature unit 12, 14 and hence the plunger out of the yoke core section 22 to the left in the axial direction in the plane of the figure, exerting a movement-inducing force on the valve slide unit 10 in the process.

As shown in the sectioned view in FIG. 1, the coil holder 26 is moreover sealed relative to the housing elements 16, 18 by means of ring seals 32, 34.

In the detail view, FIG. 3 illustrates the engagement-side construction of the plunger unit with a cage-like holding portion, in which a running or bearing ball 36 is rotatably mounted. More precisely, the arrangement in FIG. 1 and FIG. 3 has at the end a hollow-cylindrical recess 38 in the plunger unit as a receiving chamber for the ball 36, said ball being held by means of an undercut 40 at the outer end of the plunger unit (or a wall of the receiving chamber 38), in the form of an undercut oriented inward toward the longitudinal axis or axis of movement. Through appropriate dimensioning of said undercut—as shown in FIG. 3, said undercut has a radial extent b corresponding to 0.1 mm in the case of a typical ball diameter d of 4 mm—the ball 36 can be held reliably in a freely rotatable manner in the chamber 38 and, at the same time, in a manner advantageous for simplicity of assembly, the insertion of the ball 36 is effected simply by clipping it in (associated with a resilient yielding of the undercut portion 40). In this case, the chamber 38 is dimensioned radially in such a way that a radial clearance s between an outer wall of the ball and a radial inner wall of the ball allows sufficient rotatability in accordance with the invention, with lubricant that is additionally present promoting this.

The outcome achieved by means of this measure is that the operating situation shown for instance in FIG. 2 (where a center line 50 of the valve slide is offset transversely from the longitudinal axis 52 or axis of symmetry of the plunger unit by an offset v of . . . mm) when the end of the valve slide unit 10 is moved can simply be accommodated by rotation of the ball 36. In particular, this avoids a situation where abrasion and correspondingly unwanted wear occurs (as in the known case of a static engagement end of the plunger unit, for instance); it has also been found that absorption, in particular frictional force absorption, by a unit embodied in accordance with the invention can amount to about 20 times the force introduced in the case of static technologies, with the additional advantage that the (maximum permissible) axial offset need be controlled significantly less accurately and that correspondingly larger manufacturing tolerances can be permitted, with resulting cost reductions.

As a variant of the illustrative embodiment shown, it is possible according to the invention to achieve the free running of the ball in the cage-like holding portion at the end that takes place in the context of the invention by means of flanging or folding at the end of the plunger (thus effecting the locking of the ball 36 in the chamber 38), and, here too, the integral approach with its advantages in terms of manufacture is adopted, i.e. no further component is required, which is advantageous (even if this would in principle be possible within the scope of the invention in order to hold the running or bearing ball reliably in the cage-like holding portion in the required manner).

The outcome is that, by means of the present invention, adaptation of electromagnetic actuating devices to interacting actuating partners, especially switching valves or the like, where, owing to manufacturing or temperature-related tolerances, coaxial interaction cannot always be achieved but an axial offset in a direction perpendicular to the actuating direction has to be accommodated, is achieved in a surprisingly simple and elegant manner.

1-10. (canceled)

11. An electromagnetic actuating device comprising an armature unit, which can be moved by energizing a stationary coil unit (26, 38) and has a plunger unit (12) for carrying out a linear actuating movement, wherein the plunger unit is designed to interact at the end thereof with an actuating partner (10), the plunger unit has a bearing ball (36) at the end thereof, which is held movably in a cage holding portion (38, 40) of the plunger unit in such a way that it can perform a rotary movement in reaction to a frictional force acting perpendicularly to the direction of the linear actuating movement.

12. The device as claimed in claim 11, wherein the cage holding portion allows snap-fitting insertion or clipping in of the bearing ball during assembly.

13. The device as claimed in claim 11, wherein the cage holding portion has at an end thereof a snap-fitting and/or locking portion (40), which, at least in a section, reduces a clear width of a receiving chamber for the bearing ball to a dimension which is less than that of the ball diameter, measured in the direction perpendicular to the direction of the linear actuating movement.

14. The device as claimed in claim 13, wherein the locking portion is achieved by means of edge flanging or folding of at least a section of a wall delimiting the receiving chamber (38).

15. The device as claimed in claim 13, wherein the snap-fitting and/or locking portion is achieved by means of an undercut (40) formed on or in the edge of a section of a wall delimiting the receiving chamber (38).

16. The device as claimed in claim 13, wherein a reduction in a clear width takes place radially in a direction perpendicular to the linear actuating movement, to a dimension (b) which is between 0.5% and 5%, relative to the diameter of the bearing ball.

17. The device as claimed in claim 11, wherein a clear inside width of the cage holding portion perpendicular to the direction of the linear actuating movement is adapted by means of a predetermined clearance to a diameter of the bearing ball.

18. The device as claimed in claim 13, wherein an axial depth of the receiving chamber is dimensioned in such a way that the running or bearing ball projects by between 10% and 30%, relative to the ball diameter, from a front end surface of the plunger unit.

19. The device as claimed in claim 11, wherein the actuating partner is designed as a valve assembly of a switching valve.

20. The device as claimed in claim 19, wherein the switching valve is designed for camshaft adjustment on an internal combustion engine.
